(19) United States
(12) Patent Application Publication
(10) Pub. No.: US 2007/0246634 A1
(43) Pub. Date: Oct. 25, 2007

(54) Motor and Gear Unit Assembly

(76) Inventor: Dirk-Olaf Leimann, Edegem (BE)

Correspondence Address: YOUNG & THOMPSON, 745 SOUTH 23RD STREET, 2ND FLOOR, ARLINGTON, VA, 22202, US

(21) Appl. No.: 11/596,394

(22) PCT Filed: May 3, 2005
(86) PCT No.: PCT/BE05/00068

§ 371 Date: Jan. 11, 2007

(30) Foreign Application Priority Data
May 15, 2004 (GB) 0410900.5

(51) Int. Cl. F16M 13/00

(52) U.S. Cl. 248/637

(57) ABSTRACT

A motor and gear unit assembly including a gear unit, a motor and a structural connector to which the gear unit and motor are secured, the connector being of a substantially elongate shape which extends substantially parallel with the rotational axis of a transmission member which interconnects the axially spaced motor and gear unit, the connector having at least a part which is substantially planar and which, in use, is orientated to lie in a substantially vertical plane, one of the gear unit end and motor end of the connector being supported and secured or adapted for securing to supporting structure and the other of the gear unit end and motor end of the connector being secured or securable relative to the supporting structure substantially solely by the length of the elongate structural connector between the supported end and the other of the gear unit end and motor end.

This invention relates to a motor and gear unit assembly, and in particular an assembly of the type in which a structural connector is provided to form a structural interconnection between the housing of a gear unit and the housing of an electric motor.

The invention relates also to use of a structural connector for providing a structural interconnection between a foot-mounted type electric motor and either a right angle or parallel type gear unit whereby said electric motor and gear unit are positioned for torque transmission therebetween and may be supported, by means of the structural connector, relative to equipment to which an output shaft of the gear unit is connected. Thus the motor may be secured to that distal end of the structural connector at which the connector is substantially unsupported other than by supporting structure connected to the gear unit end.

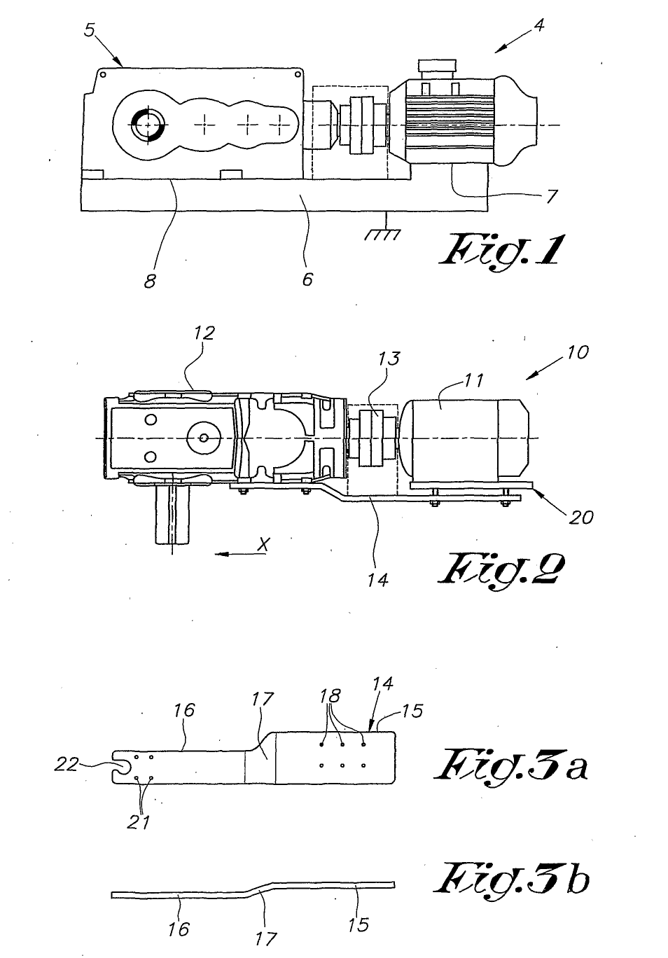

For driving conveyors it is common to employ shaft mounted gear units of the kind comprising a hollow shaft. To connect the gear unit in an aligned relationship with a foot-mounted motor and other components such as brakes it is common to employ a structural support bed as shown in FIG. 1 and comprising an integral assembly of welded components, or a casting, that provides base plate surfaces to which the gear unit and electric motor are respectively mounted. Standardisation of the design of the structural support beds is difficult because of the variation of sizes and heights of the motors and gear units which it may be wished to interconnect, and also the required spacing of the gear unit and motor, for example to accommodate different types of couplings and brakes. Furthermore, the manufacture, handling and transportation of the support beds is difficult, particularly for those structural support beds required to be of great length. Thus the present design is expensive and inconvenient.

One object of the present invention is to provide a motor and gear unit assembly in which a motor and gear unit are interconnected by a structural connector, and in which at least some of the aforedescribed disadvantages of known structural support beds are mitigated or overcome.

In accordance with one of its aspects the present invention provides a motor and gear unit assembly comprising a gear unit, a motor and a structural connector to which the gear unit and motor are secured, said structural connector being of a substantially elongate shape which extends substantially parallel with the rotational axis of a transmission member which interconnects the axially spaced motor and gear unit, said structural connector having at least a part which is substantially planar and which, in use, is orientated to lie in a substantially vertical plane, one of the gear unit end and motor end of the structural connector being a supported end which is secured to or adapted for securing to supporting structure and the other of the gear unit end and motor end of the structural connector being secured or securable relative to said supporting structure substantially solely by the length of said elongate structural connector between the supported end and said other of the gear unit end and motor end, wherein the motor has a primary direction of rotation, and the motor and gear unit are secured to that side of the structural connector which, in use, with the motor rotating in said primary direction, results in the structural connector experiencing a reactive torque which acts in a direction opposite to the torsional load transmitted along the length of the structural connector to the supported end due to the weight of said motor or gear unit acting at a centre of gravity position displaced horizontally from the plane of said structural connector.

The invention may be applied to motor and gear unit assemblies of any power rating but is particularly suitable for motor and gear unit assemblies having a power rating of less than 1500 KW and more particularly less than 750 KW.

The invention is particularly suitable for use with electric motors but may be employed also in relation to motors of other types, such as hydraulic motors,

At the supported end the structural connector may be secured or securable directly to a supporting structure or may, for example, be secured or securable via an intermediate component such as a housing of the gear unit or motor.

A particular feature of the present invention is that it obviates the need to provide a structural support or connector of a complex construction. Thus the need to provide an assembly of welded components, or a casting, is obviated. However, the invention envisages that particularly for motor and gear assemblies of a relatively high power rating, or of an above average spacing of the motor and gear unit, the structural connector may be of an enhanced torsional stiffness. Thus, instead of comprising simply a plain sheet of steel or other such material, the structural connector may be of a box type construction, or provided with reinforcing ribs thereby to provide a torsional stiffness greater than that of a single planar sheet of material of corresponding weight.

Although the motor and gear unit may be mounted directly to the structural connector, the invention contemplates also that use may optionally be made of intermediate spacer units to selectively space a motor or gear unit from the structural connector in order to achieve alignment of the axes of rotation of the motor and gear unit input.

The substantially planar structural connector may be truly planar, or may, for example, comprise two sections which are each substantially planar but displaced from one another by an intermediate section whereby said two substantially planar sections lie in planes spaced apart but substantially parallel with one another.

The invention will now be described, by way of example, with reference to the accompanying diagrammatic drawings in which:

FIG. 1 is a side view of a known motor and gear unit assembly;

FIG. 2 is a plan view of a motor and gear unit assembly in accordance with the present invention;

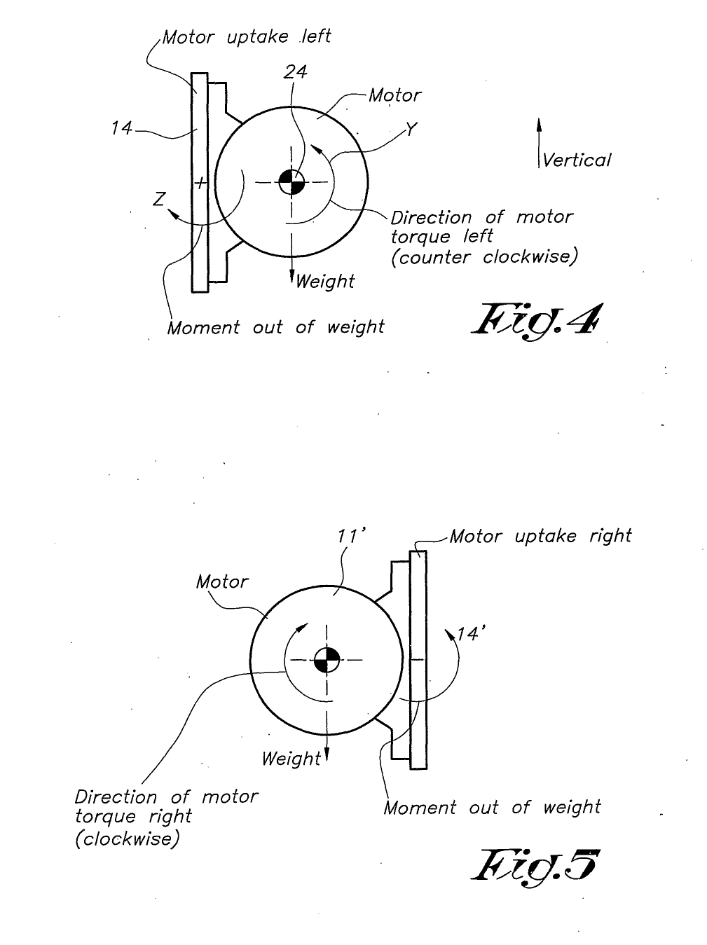

FIGS. 3a and 3b are side and plan views of the structural connector of the assembly of FIG. 2;

FIG. 4 is an end view in the direction of the arrow X of FIG. 2, and

FIG. 5 is an end view of a motor and gear unit assembly in accordance with a second embodiment of the invention.

FIG. 1 shows an electric motor 4 and a gear unit 5 each having mounting feet which are secured to a cast iron support bed base plate 6. The base plate 6 has machined surfaced regions 7, 8 to which the motor and gear unit are respectively secured. In order to ensure that alignment of the rotational axis of the motor and the gear unit is not adversely affected, it is necessary to ensure that the machining of the surfaces 7, 8 of the support bed is accurately controlled.

A gear unit and motor assembly in accordance with the present invention is illustrated in FIG. 2.

The motor and gear unit assembly 10 shown in FIG. 2 comprises a motor 11, a gear unit 12, a transmission coupling 13 for transmission of torque between the motor and gear unit, and a connector plate 14 which provides a structural interconnection between the motor and gear unit.

The connector plate 14 comprises two end sections, a motor end 15 and a gear unit end section 16 which are each of substantially planar form, and said sections being interconnected by a central connection section 17 such that the two end sections 15, 16 lie in planes slightly overset from one another but substantially but parallel.

The motor end 15 is provided with a series of apertures 18 by means of which the motor 11 may be secured to the connector plate 14. In this embodiment the motor is not mounted directly to the plate section 15, but is spaced slightly therefrom by an intermediate spacer unit 20 of a type as more specifically described in the specification of our co-pending UK patent application of even date and entitled Structural Connection of a Motor and Gear Unit. That intermediate spacer unit serves to enable the rotational axes of the motor and gear unit input to be aligned and enable to torque to be transmitted by the interposed coupling 13.

The gear unit end section 16 of the connector plate 14 is also provided with apertures for enabling the gear unit to be bolted to the connector plate. Additionally, to augment that bolted interconnection, the end edge region 22 of the section 16 is provided with a profile which complements the profile of a protrusion provided on the gear unit housing such that relative rotational movement of the gear unit relative to the plate, in the plane of the plate, such as due to the output torque forces, is resisted by that interlock in addition to the bolts in the holes 21.

FIG. 4 is an end view in the direction X of FIG. 2 and shows an arrangement in which the primary direction of rotation of the motor is counterclockwise as viewed in the direction X. In use of the motor and gear unit assembly that results in the connector plate 14 experiencing a reactive torque in the direction Y. That torque, however, acts in a direction opposite the torque acting in the direction Z due to the weight of the motor acting at a centre of gravity position 24 which is offset horizontally from the vertical plane of the plate 14. Thus the torque loading experienced by the connector plate 14 is always the difference between the aforementioned torques rather than the summation of those torques.

FIG. 5 shows a second embodiment in which the primary direction of rotation of the motor is clockwise. Accordingly, in this embodiment the motor 11 is mounted to the left of the plate 14 such that, as in respect of the first embodiment, the net torque experienced by the connector plate, i.e. the torque which needs to be transmitted from the distal end of the plate 14 to the supported end 16 to which supporting structure (not shown) is secured, is similarly the difference between the two torques and not the summation thereof.

1. A motor and gear unit assembly comprising a gear unit, a motor and a structural connector to which the gear unit and motor are secured, said structural connector being of a substantially elongate shape which extends substantially parallel with the rotational axis of a transmission member which interconnects the axially spaced motor and gear unit, said structural connector having at least a part which is substantially planar and which, in use, is orientated to lie in a substantially vertical plane, one of the gear unit end and motor end of the structural connector being a supported end which is secured to or adapted for securing to supporting structure and the other of the gear unit end and motor end of the structural connector being secured or securable relative to said supporting structure substantially solely by the length of said elongate structural connector between the supported end and said other of the gear unit end and motor end, wherein the motor has a primary direction of rotation, and the motor and gear unit are secured to that side of the structural connector which, in use, with the motor rotating in said primary direction, results in the structural connector experiencing a reactive torque which acts in a direction opposite to the torsional load transmitted along the length of the structural connector to the supported end due to the weight of said motor or gear unit acting at a centre of gravity position displaced horizontally from the plane of said structural connector.

2. A motor and gear unit assembly according to claim 1, wherein said structural connector comprises sheet steel.

3. A motor and gear unit assembly according to claim 1, wherein the structural connector is of a box type construction.

4. A motor and gear unit assembly according to claim 1, wherein the structural connector, is provided with reinforcing ribs orientated to enhance torsional stiffness of the structural connector.

5. A motor and gear unit assembly according to claim 1, wherein the elongate structural connector is arranged, in use, to extend in a substantially horizontal direction.

6. A motor and gear unit assembly according to claim 1, wherein the structural connector comprises two sections which are each substantially planar and displaced from one another by an intermediate section whereby said two substantially planar sections lie in planes spaced apart but substantially parallel with one another.

7. A motor and gear unit assembly according to claim 1, and comprising an intermediate spacer unit to space a motor or gear unit from the structural connector.

8. A motor and gear unit assembly according to claim 1, and substantially as hereinbefore described.

9. A motor and gear unit assembly according to claim 2, wherein the structural connector is of a box type construction.
